(19) United States
(12) Patent Application Publication
(10) Pub. No.: US 2026/0037509 A1
(43) Pub. Date: Feb. 5, 2026

(54) PARALLELIZING USER DEFINED FUNCTIONS IN A SQL DATABASE

(71) Applicant: HEWLETT PACKARD ENTERPRISE DEVELOPMENT LP, Spring, TX (US)

(72) Inventors: RAMAKUMAR V. KOSURU, Austin, TX (US); RONALD TISCHLER, San Jose, CA (US); MICHAEL DYSLIN, Spring, TX (US); Clifford Earl Gray, San Jose, CA (US); Javier Dupond, Spring, TX (US)

(21) Appl. No.: 18/788,521

(22) Filed: Jul. 30, 2024

(51) Int. Cl. G06F 16/2453; G06F 16/242

(52) U.S. Cl. CPC G06F 16/24542; G06F 16/2448; G06F 16/24532

(57) ABSTRACT

Systems and methods are provided for receiving, at a compiler, a structured query language (SQL) query that includes one or more user defined function (UDF) expressions. The SQL query may be compiled to generate an SQL query plan such that the UDF expression will be computed as part of an SQL operator function. The UDF expression is computed by virtue of performing the SQL operator function during execution of the SQL plan.

### BACKGROUND

Databases are electronic filing systems that store records or data in a computer system. Computer programs or users can send and retrieve data from the database using a database management system (DBMS). The amount of data stored in database systems has been continuously increasing over the last few decades, and thus, DBMSs are tasked with managing large volumes of data. Although databases manage large amounts of data, and queries to databases are becoming increasingly complex due to such massive data structures, DBMS users nevertheless desire/expect efficient access to and manipulation of data stored in databases.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 is a block diagram of a system in which examples of the disclosed technology may be implemented.

FIG. 2 is a block diagram of a database management system adapted to execute a query according to examples of the disclosed technology.

FIG. 3 illustrates a visual profile of an example query plan generated in accordance with examples of the disclosed technology.

FIG. 4 illustrates an example convolution operation that can be parallelized and applied to an image in accordance with examples of the disclosed technology.

FIG. 5 illustrates a visual profile of an example conventional query plan compared to a query plan generated in accordance with examples of the disclosed technology.

FIG. 6 illustrates an example of a query plan generated in accordance with examples of the disclosed technology where a user defined function (UDF) may be parallelized.

FIG. 7 is an example computing component that may be used to execute a UDF as a Structured Query Language (SQL) operator in accordance with examples of the disclosed technology.

The figures are not exhaustive and do not limit the present disclosure to the precise form disclosed.

### DETAILED DESCRIPTION

As noted above, databases or data repositories are being used to store massive amounts of data, making access to/manipulation of the data stored in such databases or data repositories more and more complex. Access to/manipulation of the data can be effectuated via queries, such as structured query language (SQL) queries. Some databases can be configured or designed as parallel database systems in order to improve database performance. The improvements can be realized through the parallelization of various operations, e.g., loading data, building indexes, and evaluating queries. The data itself may be stored in distributed fashion, and processing/input-output operation speed can be increased by the use of multiple CPUs and disks in parallel, avoiding serial processing, in which computational steps are performed sequentially.

NonStop SQL/MX is one example of a parallel database that utilizes a dataflow architecture on a shared nothing, message-based system. A shared nothing architecture can refer to a distributed computing model where each node in a system has its own dedicated resources (e.g., memory, storage, processing power, CPU, network interface card (NIC) buffer queries, etc.) and operates independently. A Nonstop SQL/MX database may have many cooperating processes working in parallel on given workloads, where the number of processes involved can depend on an SQL table layout, the number of CPUs or cores, the number of logical disks, the amount of work to be done with respect to joining tables, filtering data, etc.

PL/MX can refer to a procedural language for a Nonstop SQL/MX database, and is also the implementation language for user-defined routines (UDRs) in Nonstop SQL/MX. A routine can refer to a collection of program statements that perform a particular task. A UDR can refer to a routine that can be defined and invoked with an SQL statement or another UDR. The UDR can either return values or not depending on whether the UDR is a user defined function (UDF) or a user defined procedure (UDP). A UDP can refer to a routine that optionally accepts a set of arguments, but does not return any values. A UDF is a function, like functions in general, can take in one or more inputs, such as data inputs, and can then return one or more values, and therefore, can be used in SQL expressions, such as SQL queries.

In the SQL context, UDFs, which are user-defined (or customer-defined) can be distinguished from built-in functions or system-defined functions, such as a typical square root function. A UDF can be part of a predicate (basic algorithm or part of a basic algorithm) expression in a table scan, or an expression in a “having” clause for a “group-by” expression, a part of a predicate expression in a “join” expression, or part of the “select list” of a query. That is, UDFs can be used in one or more parts of an SQL query or statement, i.e., an SQL query or statement can be written or specified to include one or more UDFs. Typically, a UDF is separately called from within an SQL query and processed to, e.g., perform a general purpose computation(s) and return a result. The result can then be factored back into the SQL query.

Against this backdrop, examples of the presently disclosed technology are directed to augmenting Nonstop SQL/MX (or similar parallel) database systems to provide support for row-parallelism when invoking UDFs. In particular, UDF expressions can be made into or part of an SQL operator, making UDF expressions subject to standard SQL rules (that are followed by most/all SQL implementations). In this way, a UDF expression, such as those that perform analytics operations, become trusted/subject to the standard definition(s) of SQL, and can be executed in parallel by the SQL engine, thus taking advantage of and leveraging the capabilities of Nonstop SQL/MX parallel database systems. That is, during compilation into a query plan, the UDF expression can be optimized, and if possible, executable in parallel by the SQL engine. It should be noted that database systems can be distributed, such as a NonStop SQL/MX system, in which case, examples of the disclosed technology can effectuate parallelization across multiple parts of a database system, e.g., across nodes as discussed above. However, a single database instance can also be partitioned, and the contemplated parallelization of UDFs can also be effectuated across different partitions of a database instance.

Moreover, by transforming a UDF expression into an SQL operator, the UDF logic is moved closer to the data itself. That is, data may be maintained in a database, as discussed above, and a user may wish to perform some SQL query on that data. As an example, the SQL query may be a query to a table maintaining data comprising encrypted orders of some vendor having two columns, an unencrypted order key column, and an encrypted profit margin column. The SQL query is defined to extract and decrypt those rows satisfying some condition, e.g., where the profit margin is less than a given dollar amount (where order records are stored in a row, and the data elements of the row, i.e., the unencrypted order key and encrypted profit margin data are stored in columns).

Conventionally, an SQL compiler would generate a plan to effectuate the above-described query with a decrypt function. That plan would involve, first, performing a file scan operation on/close to the disk, i.e., the database. If that disk/database contained 100,000 rows, the file scan operation would have to scan all 100,000 rows, and send the 100,000 rows to a nested join operator. The nested join operator would send the 100,000 rows to another operator where a comparison could be made to see which rows meet the profit margin condition, and where those rows meeting the profit margin condition would be decrypted. If, for example, eight rows met the condition, those selected eight rows would be decrypted and sent back to the nested join operator, which in turn, would return the eight rows to a root operator of the plan. One can appreciate that large amounts of data (e.g., the 100,000 rows of data) are being sent back/forth between operators (at times, away from the disk), and various operations are being performed to effectuate the desired SQL query. Such transmission of data and the performance of such operations can be costly (in terms of latency and compute resources/power)

In contrast, and in accordance with examples of the disclosed technology, much simpler, and much less costly plans can be generated by an SQL compiler. For example, and as will be described in greater detail below, the decrypt function could be compiled into an SQL query that can be performed at/close to the disk. Thus, as part of the file scan, the decrypt function can read a row, determine that the row is encrypted, decrypt the row, and perform the comparison to determine if the row meets the profit margin condition. Despite still having to decrypt 100,000 rows of data, only the selected eight rows are returned to the parent operator. One can appreciate the reduction in number of operations/processing and timing costs associated with performing the SQL query conventionally.

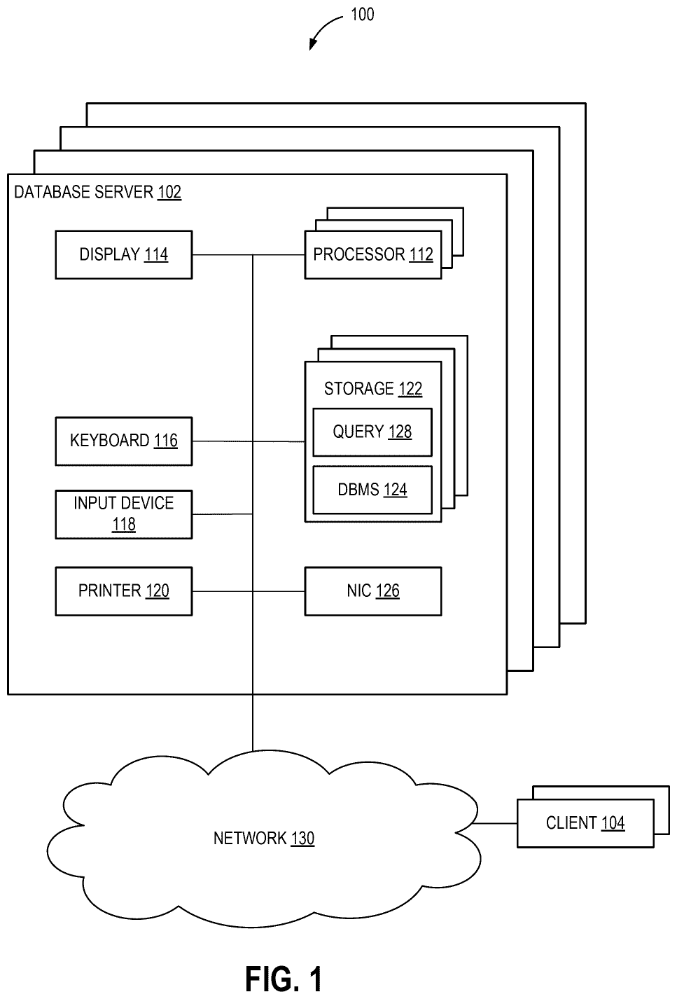

FIG. 1 is a block diagram of a system 100 adapted to execute a query according to an example of the disclosed technology. System 100 may include a database server 102, and one or more client computers 104, in communication over a network 130. As illustrated in FIG. 1, the database server 102 may include multiple processors 112 acting in parallel. The processors 112 may be connected through a bus 113 to a display 114, a keyboard 116, one or more input devices 118, and an output device, such as a printer 120. The input devices 118 may include devices such as a mouse or touch screen.

System 100 may include multiple database servers 102 in a massively parallel processing system (MPP). In such an example, system 100 may include a shared nothing architecture. Database server 102 may also be connected through bus 113 to a network interface card (NIC) 126. NIC 126 may connect database server 102 to network 130. Network 130 may be a local area network (LAN), a wide area network (WAN), or another network configuration, such as the Internet. Network 130 may include routers, switches, modems, or any other kind of interface device used for interconnection.

Through network 130, several client computers 104 may connect to database server 102. Client computers 104 may be similarly structured as database server 102, with exception to the storage of a database management system (DBMS) 124. In one example of the disclosed technology, client computers 104 may be used to submit queries to database server 102 for execution by DBMS 124.

Database server 102 may have other units operatively coupled to the processor 112 through bus 113. These units may include tangible, machine-readable storage media, such as storage devices 122.

Storage devices 122 may include media for the long-term storage of operating software and data, such as hard drives. Storage devices 122 may also include other types of tangible, machine-readable media, such as read-only memory (ROM), random access memory (RAM), and cache memory. The storage devices 122 may include the software used in exemplary embodiments of the present techniques.

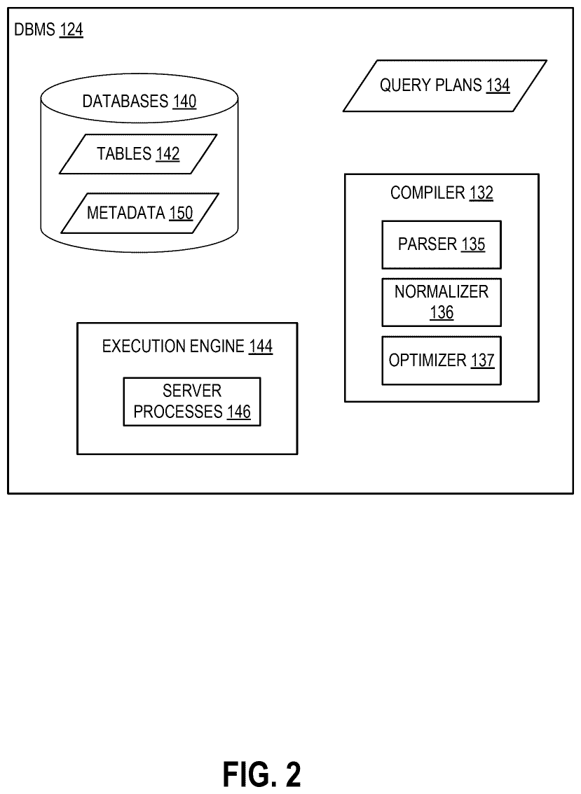

Storage devices 122 may include DBMS 124 and a query 128. DBMS 124 may be a set of computer programs that controls the creation, maintenance, and use of databases by an organization and its end users. In one example of the disclosed technology, DBMS 124 may be a parallel DBMS. DBMS 124, which may be an implementation or embodiment of the aforementioned NonStop SQL/MX database system, is described in greater detail with reference to FIG. 2. Query 128 may be any of a certain class of common database queries, such as inner or outer joins. As discussed herein, examples of the presently disclosed technology are directed to parallelizing UDF expressions as part of SQL queries that can be executed in parallel to take advantage of database servers 102 being implemented in an MPP. Thus, in some examples, UDF expressions can be made into or part of an SQL operator, which in turn, can make up at least part of an SQL query, upon compilation by an SQL compiler. The resulting plan, which may now include the UDF expression (set forth in PL/MX) can be executed in parallel on DBMS 124, which again, may be an embodiment or implementation of a NonStop SQL/MX database system.

FIG. 2 is a block diagram of (parallel) DBMS 124, adapted to execute a query according to examples of the disclosed technology. As illustrated, DBMS 124 may include a compiler 132, query plans 134, an execution engine 144, and several databases 140.

Query plans 134 may each specify alternate ways to perform the query 128. Compiler 132 may be software that generates the query plans 134, which are implemented at runtime by execution engine 144.

Compiler 132 may comprise several modules, including, but not limited to, a parser 135, a normalizer 136, and an optimizer 137, that may perform a separate phase of query plan generation.

In one phase, parser 135 may perform syntax checking on query 128. Parser 135 may also build a query tree, which may be an algebraic tree representation of query 128. In another phase, normalizer 136 may transform the query tree into a form for optimization, such as a canonical tree form.

In yet another phase, optimizer 137 may generate several query plans 134 to determine the execution strategy for query 128. Query plans 134 may be based on the query tree in the canonical tree form. Query plan 134 with the minimal processing cost may be selected for the execution strategy.

Databases 140 may include user data organized into tables, columns, and rows. Databases 140 may also include metadata 150, e.g., a collection of statistics about the data in the databases. Metadata 150 may describe data values within the databases, the frequency of occurrence of particular values, and the like. Typically, DBMS 124 updates metadata 150 after data is loaded into databases 140, or whenever the data in databases 140 has changed substantially via insert, update, and delete operations.

Execution engine 144 may include server processes 146. Operations within query plan 134 may be delegated to one or more of the server processes 146, each of which may execute a subset of the query plan 134 on some partition of data. In an embodiment comprising the MPP, each of the server processes 146 may execute in parallel on different processors 112.

As noted above, and as will be discussed in greater detail below, UDF expressions can be transformed into an SQL operator pursuant to compilation, in this example, by compiler 132. Compiler 132 may read textual input (source file/SQL query or statement), break the textual input into tokens, e.g., by preprocessing. Compiler 132 may then parse those tokens to check the semantics of the textual input/written SQL query or statement. That is, in various examples, parser 135 may perform syntax checking on query 128, which can be an SQL query that may include a UDF expression. Parser 135 may also build a query tree, which may be an algebraic tree representation of query 128 (also referred to as a query tree). The generation of an abstract syntax tree can capture the labeled syntactic structure of query 128, and may further glean other information during the reading of the textual input/parsing that can be used to implement some optimization(s). Normalizer 136 can transform the query tree into a format for optimization, such as a canonical tree form. Optimizer 137 may then generate one or more query plans 134, which can be query plans effectuating the SQL operator built based on the UDF expression. An optimal or preferred query plan, if more than one is generated, can be selected for execution by execution engine 144 on databases 140 of DBMS 124.

During execution of the query plan, the UDF expression can be performed/computed as or as part of a standard SQL operator. This is in contrast to the above-described conventional approach of separately calling the UDF expression within an SQL query, processing the UDF expression, and returning a result, which is then factored back into the SQL query. Because UDF expressions (written in e.g., PL/MX) can be made into/as part of SQL operators, the processing of UDF expressions can be performed at/near the disk where the data is stored (to avoid excessive data shipping to other parts of a query plan). Moreover, UDF expressions made into/as part of SQL operators can be parallelized if such an optimization via compilation is possible. It should be noted that other optimizations may also be possible. For example, a UDF may be placed at an appropriate location based on the selectivity of the predicate. If a predicate is highly selective, then it may be placed at the disk level. If the selectivity is low, then the optimizer, e.g., optimizer 137, may choose to place the UDF at another location where the selectivity is higher, such as at a join elsewhere in the query plan tree. Another example is that a UDF may be part of a “before” trigger.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

As noted above, NonStop PL/MX is a procedural language (similar to C), while SQL is a declarative language. Although NonStop SQL/MX has been adapted to call procedures and functions written in the NonStop PL/MX language, this support is limited, and no parallelism is supported. Through the use of examples of the disclosed technology, general purpose UDFs can be extended to support row parallelism so that UDF operations, such as expensive UDF operations, can be parallelized. That is, the functionality of the SQL language can be extended or enhanced to include, e.g., user written business logic transformations or data manipulation techniques. Again, and as already discussed, UDFs are typically called and executed away from the data/disk, where a result of the UDF is factored back into the SQL query.

Example scenarios describing how a UDF expression (included as a part of a SQL query) can be made into or made a part of an SQL operator will now be discussed. The to-be-discussed examples relate to dot product and convolution operations that are widely used in machine learning (ML) analytics libraries, which can now be performed at or nearer to the data/disk, thereby avoiding the conventional shipping of data to an analytics operation if the analytics operation is performed outside the query engine. In contrast, examples of the disclosed technology can be characterized as shipping the logic to the data. For example, generative artificial intelligence (AI) transformer logic is based on linear algebra. In particular, matrix multiplication (dot product) can be used to predict a next token based on received textual input. As another example, convolution operations, commonly-used in image processing and other modern applications, can also be “simulated” or represented as a UDF to facilitate image processing.

Moreover, parallelization can be particularly advantageous in analytics operations, where a user may define a function meant to perform some analytics operation, and thus, the parallelization of the dot product and convolution operations will also be discussed herein. As noted above, parallelization can occur in various contexts, and following the above examples, will be discussed in the context of disk level parallelism and server process parallelization.

Assume a p-way partitioned table TC1 with at least two columns C1, C2. Column C1 embeds an m-ary vector and column C2 embeds an n-ary vector, where n≥m. A dot product operation may be defined as follows:

$${D}_{row} = {\sum }_{i = 1}^{m} C {1}_{i} * C {2}_{i}$$

It can be assumed that m=n, where this particular dot product operation, a UDF dot product, may take as input, two arguments C1 and C2 (corresponding to the two columns of the p-way partitioned table TC1), and returns a result by computing D_{row}. This dot product operation involves multiplication and addition. The multiplication of C1 and C2 is performed over the range of 1 to m, and the resulting products of C1 and C2 are added (the summation of the product from i=1 through i=m, recalling that columns C1 and C2 are m-ary/n-ary vectors meaning there are m/n values in the vector). In SQL, this is expressed as an SQL query, i.e., “select dotproduct(C1,C2) from TC1.”

The SQL compiler, e.g., above-described compiler 132 (FIG. 2), generates a query plan, where the dot product UDF is computed at a SQL scan operator. The SQL query (including one or more UDFs) is analyzed by the SQL compiler and gleans an understanding of the context of the UDF by interfacing with, e.g., a catalog manager, a PL/MX manager, etc., and creates a query plan

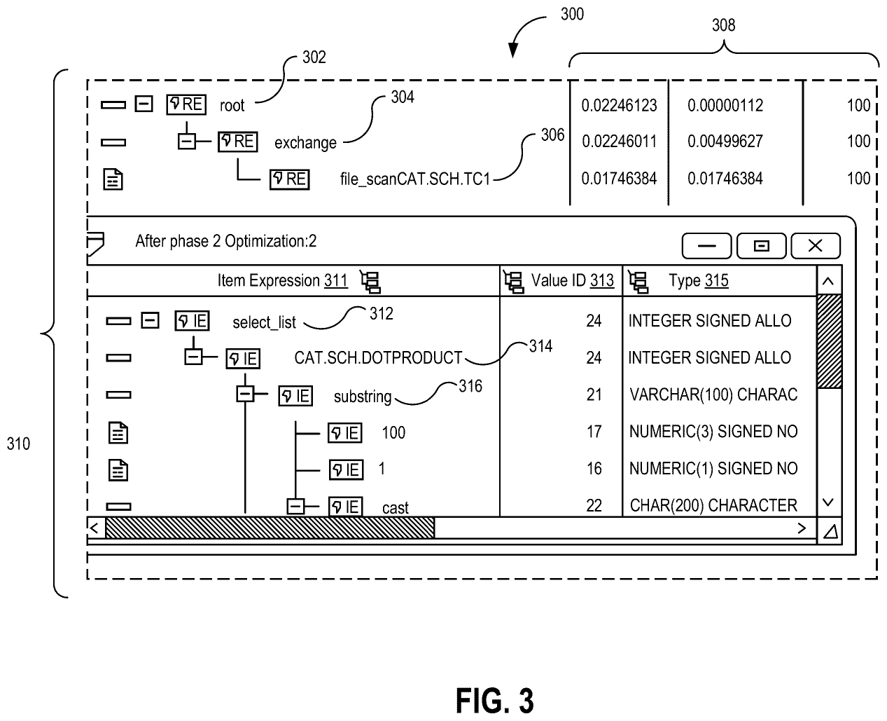

FIG. 3 illustrates an example visual profile 300 of operations comprising an SQL query plan, such as that which may be generated by compiler 132 (FIG. 2). Visual profiles can be used to diagnose performance or cost issues to see the results of changes that may have been made to a query itself or to the database to which query is applied, etc. A query plan typically comprises query phases, each of the query phases defining operations that can be run in parallel.

In the example illustrated in FIG. 3, the query plan 310 is derived or generated based on (following the above example), an SQL query that wishes to select the dot product of the columns C1 and C2 of table TC1. The query plan comprises operators that can be arranged as a tree (item expression 311), where an operator may have one or two upstream operators that represent some action, e.g., table scan, join, or sort. At the top of the tree, a parent or root operator 302 can represent the query results. An exchange operator 304 is an abstraction of parallelism (any operation “under” exchange operator 304), in this example, a file_scan operator 306 that scans table TC1. This file_scan operation can be run/executed in parallel across nodes or partitions.

In operation, the SQL query/statement can be used to generate a query plan 310 (which may be an embodiment of query plans 134 of FIG. 2). The query plan 310 can be sent to an execution engine, e.g., a PL/MX execution engine (such as execution engine 144 of FIG. 2). The code for the defined UDF can be obtained, and the code can be sent to the disk process (not shown, part of databases 140 of FIG. 2), which in turn may send the code to file_scan operator 306. File_scan operator 306 can pass the UDF code to the dot product expression/operator 314 that falls under the select_list operator 312, where dot product expression 314 invokes the dot product operation. It should be understood that the select_list operator 312 and the dot product operator 314 can be attached to any operator, in this example the root operator 302 or the file_scan operator 306. However, in accordance with phase 2 optimization, query plan 310 can optimize the SQL query by parallelizing the file_scan operation-hence, attaching the select_list operator 312 and the dot product operator 314 to file_scan operation 306, where the select_list operator 310 is interested in selecting substring 316, and only in the first 100 places.

A query plan, such as query plan 310, contains operators, and each operator has a cost. The numbers 308 reflect costs and cumulative costs (from the bottom of the query tree 310) of the operators. The “Value ID” 313 is a unique value (a number) that is assigned to each expression. The “Type” 315 refers to the SQL database type of the expression.

If the table TC1 has one million rows, the UDF will be invoked one million times. Conventionally, invocation of the UDF would be done serially, but instead, in accordance with examples of the disclosed technology, the UDF has been parallelized by pushing the UDF function down to other SQL operators such as a scan, join and other operators (in this example, file_scan operator 306). The table TC1 as explained above, can be a p-way partitioned table, and therefore the degree of parallelism for this operation is p (in this example p=4). The “exchange” operation encapsulates parallelism as described above (versus a serial plan where the degree of parallelism is one). In this way, the file_scan operation takes place in parallel on, e.g., 4 disk processes running simultaneously on different CPUs. When the NonStop SQL/MX compiler, e.g., an embodiment of compiler 132 of FIG. 2, makes a determination that it is safe to push down the UDF operation to file_scan operator 308, the UDF will be made part of the parallelized file_scan operation. It should be noted that if UDF execution is very resource intensive, parallelism can nevertheless still be enabled by distributing the UDF among several worker processes (executor server processes). In this example, parallelism as well as the elimination of data shipping by executing the operator at the data is achieved.

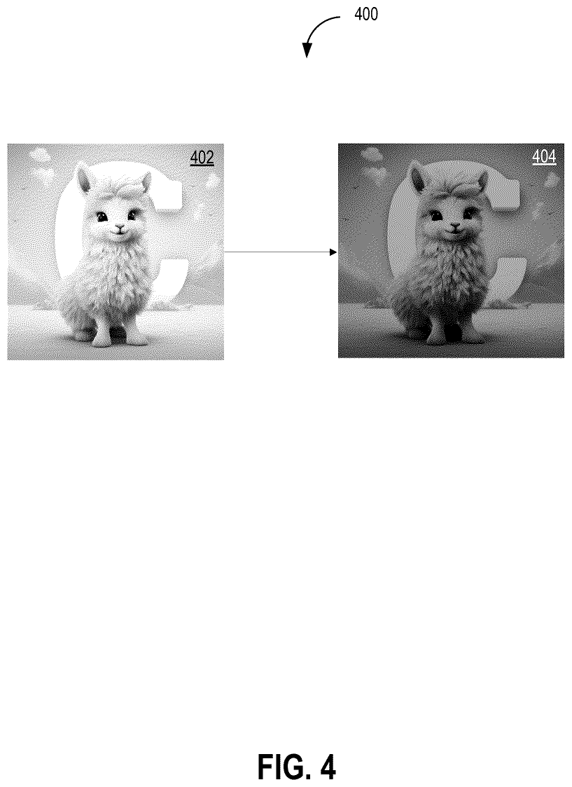

Another example, where a convolution operation is parallelized/moved to the data, will now be discussed. A convolution operation may linearly transform a weighted matrix (W) by a kernel feature matrix/vector (F). In general, feature vector values are learned by training. Different feature vectors may be applied depending on what a user wishes to infer. Possible uses are to recognize boundaries in an image, to generate a reflection, or to recognize a particular rotation of an image. FIG. 4 illustrates an example convolution as applied to an image 402. The convolution by a kernel vector of size 5 can be used as a regularization (reducing values of the matrix of the image to avoid having to process large values which would otherwise be represented with more bits/bytes). This results practically in “dimming” image 402 to result in image 404, where the vectors can represent, e.g., RGB values.

The matrix W can be an m×n image matrix, and the feature vector F can be a one-dimensional matrix with f entries, e.g., F (0.1,0.01,0.1,0.11,0.12). The convolution operation integrates the product of two functions and can be an important primitive in ML libraries. In particular, the entries of matrix W are short integers encapsulating image 402, and the vector F encapsulates a scaling operation. The output can be an m×n matrix (called A), whose entries are short integers. The rows and columns of a vector or matrix are numbered starting at 1. Thus, the elements of matrix W are denoted W_{i,j} for i=1, . . . , m, j=1, . . . , n, (and similarly for matrix A). The entries of Fare Fₖ, for k=1, . . . , f. The first step in the calculation is to extend matrix W with (f−1) additional columns of zeroes, so that now, matrix W is an m×(n+f−1) matrix. Accordingly, the formula for convolution, for i=1, . . . m, j=1, . . . n, is:

$${A}_{i , j} = {\sum }_{k = 1}^{f} {W}_{i , j + k - 1} {F}_{k}$$

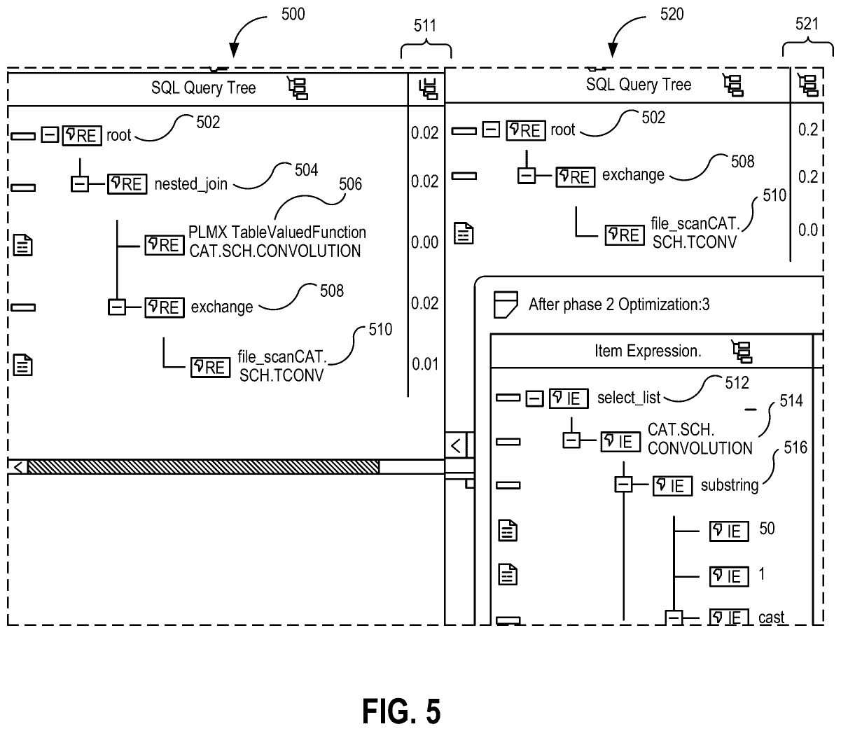

This convolution operation can be implemented, where the weight matrix W is scaled by the feature vector F, and where parallelization of this convolution operation can be achieved by performing several one-dimensional convolutions in parallel. The smaller feature vector F can be replicated across all instances of a file_scan operation as a column of a table, TCONV. The rows from the matrix W can be distributed over different partitions of the table TCONV. Again, one-dimensional convolutions can be easily parallelized, and can be combined with an SQL “order by” operation on rows of the computed matrix A. The SQL query can be set forth as follows: Select substring (convolution(c1,c2),1,50) from TCONV order by a. The “order by” operation can be invoked to sort rows of the computed matrix A in correct order. FIG. 5 illustrates an example serial query plan 500, where serial query plan 500 includes root operator 502, a nested_join operator 504, a UDF, i.e., PL/MX TableValuedFunction convolution operator 506, exchange operator 508, and file_scan operator 510. The costs associated with the operators are reflected as values 511. In this example, the file_scan operator 510 is used to feed data to the PL/MX TableValuedFunction 506. Here, the UDF (PL/MX TableValuedFunctionCAT.SCH.CONVOLUTION), as described above, is its own operator that is called/executed.

In contrast, the query plan 520 is a parallelized query plan that can be generated in accordance with examples of the disclosed technology. Here, as with the previous example (illustrated in FIG. 3), the convolution UDF expression 514 becomes part of file_scan operator 510. Moreover, there is no need for a nested join operator, as the UDF expression/operation 514 can be invoked at the data/disk, where the convolution is to be performed in accordance with a substring selection (effectuated by select_list operator 512) of the first 50 places of substring 516. The costs associated with the operators are reflected as values 521.

As discussed above, examples of parallelism can encompass disk parallelism based on partitioning of an SQL table. In other examples, disk parallelism can be the result of hash partitioning or data range partitioning. However, not all operations can be parallelized at the disk level. Accordingly, in accordance with other examples of the disclosed technology, parallelization has been extended to encompass or include “server process (ESP)” parallelism. For example, if a UDF contains arguments from two different SQL tables, subject to SQL/MX compiler intelligence, the UDF expression can be pushed to a SQL relational join operator. The SQL relational join operator can execute either serially or in parallel among ESPs. It should be noted that ESP parallelism is more powerful in a NonStop SQL/MX system than disk parallelism, and examples of the disclosed technology can exploit this ESP parallelism.

A join operation example is set forth below, where a plurality of UDFs (select factorial, where, and add2) appear as a predicate:
select factorial(t1.a),t2.b from t1, t2
where not(factorial(t1.a)>t1.b or
add2(t2.a, t2.b)>t1.a);

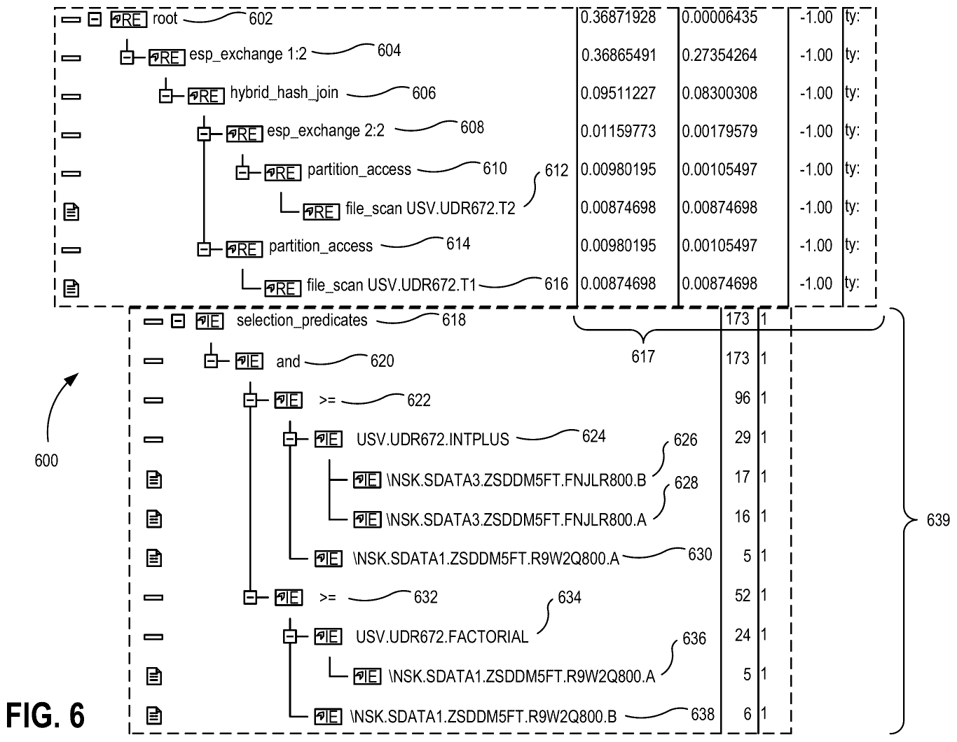

In the generated SQL query plan illustrated in FIG. 6, the hybrid_hash_join operator 606 appears below the exchange operator 604 and root operator 602. Exchange operator 604 is an abstraction of a process boundary, where there is one root operator 602 communicating with two join operators (hybrid_hash_join operator 606) running in parallel for joining tables T1 and T2 (scanned by file_scan operators 612 and 616, respectively). That is, the join operation is being performed in parallel in two different ESP processes, defined in this example by partition_access operators 610 and 614. Moreover, the predicate of the join operation (performed by hybrid_hash_join operator 606) is executed for each row of the parallel join operation. Another exchange operator 608 is used for allowing partition access and file scanning of table T2. The two exchange operators, corresponding to processes that run in parallel, are distinguished by numbers “1:2” and “2:2”. Selection predicate expression 618 computes the “where” clause in the above-noted join operation via “and” expression 620, “>=” expressions 622 and 632, and invoking instances of the UDFs 624-630, 634-638.

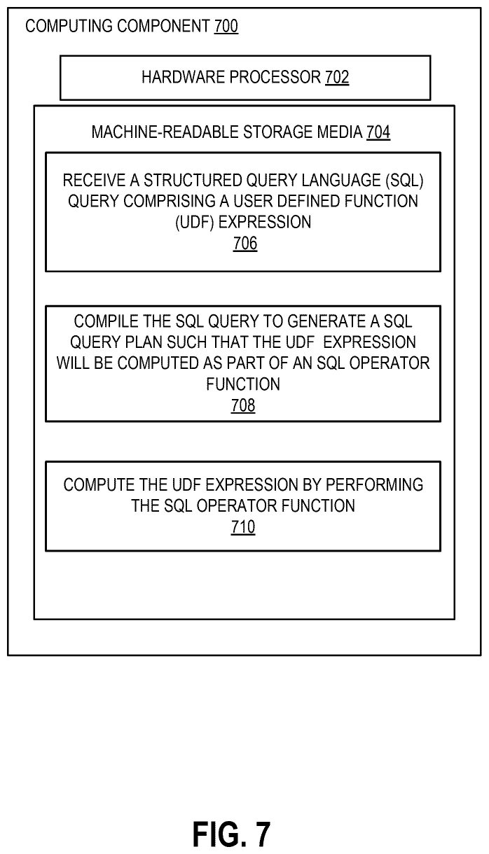

FIG. 7 illustrates a computing component that may be used to implement burst preloading for available bandwidth estimation in accordance with various examples of the disclosed technology. Referring now to FIG. 7, computing component 700 may be, for example, a server computer, a controller, or any other similar computing component capable of processing data. In the example implementation of FIG. 7, computing component 700 includes a hardware processor 702, and machine-readable storage medium 704.

Hardware processor 702 may be one or more central processing units (CPUs), semiconductor-based microprocessors, and/or other hardware devices suitable for retrieval and execution of instructions stored in machine-readable storage medium 704. Hardware processor 702 may fetch, decode, and execute instructions, such as instructions 706-710, to control processes or operations for making UDFs SQL operators/part of a SQL operator, such that query plans can be generated, where execution of the UDFs can be parallelized as well as brought to or at least closer to the data/disk. As an alternative or in addition to retrieving and executing instructions, hardware processor 702 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 704, may be any electronic, magnetic, optical, or other physical storage device that contains or stores executable instructions. Thus, machine-readable storage medium 704 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 704 may be a non-transitory storage medium, where the term “non-transitory” does not encompass transitory propagating signals. As described in detail below, machine-readable storage medium 704 may be encoded with executable instructions, for example, instructions 706-710.

Hardware processor 702 may execute instruction 706 to receive an SQL query comprising a UDF expression. As noted above, UDF expressions can be made into or part of an SQL operator, making UDF expressions subject to standard SQL rules such that the UDF expressions can be executed in parallel by an SQL engine, thus taking advantage of and leveraging the capabilities of parallel database systems. Parallelization can be effectuated across multiple parts of a database system, e.g., across nodes across different partitions of a database instance. Moreover, by transforming a UDF expression into an SQL operator, the UDF logic is moved closer to the data/disk itself. That is, conventionally generated query plans tend to involve “shipping” data from one operator to the next, and at times involve operations that process the data in order to make the data accessible/query-able. However, in accordance with various embodiments, much simpler, and much less costly plans can be generated by an SQL compiler. For example, a UDF expression, once made into or a part of an SQL query, can be executed or processed at the data, without having the move the data to another operator before performing the UDF expression.

Hardware processor 702 may execute instruction 708 to compile the SQL query to generate an SQL query plan such that the UDF expression will be computed as part of an SQL operator function, the UDF expression being computed by performance of the SQL operator function. A compiler may read a textual SQL query or statement, break the SQL query or statement into tokens, e.g., by preprocessing, parse those tokens to check the semantics of the SQL query or statement that may include a UDF expression. A parser module of the compiler may build a query tree, which may be an algebraic tree representation of the SQL query or statement in order to capture the labeled syntactic structure of the SQL query or statement, and may further glean other information during the reading of the textual input/parsing that can be used to implement some optimization(s). A normalizer module can be used to transform the query tree into a optimizable format, such as a canonical tree form. An optimizer module may generate one or more query plans, which can be query plans effectuating the SQL operator built based on the UDF expression. An optimal or preferred query plan, if more than one is generated, can be selected for execution.

Conventionally, a UDF expression within an SQL query would be processed. The result of the UDF expression would be returned and factored back into the SQL query. During execution of the query plan in accordance with examples of the disclosed technology, however, the UDF expression can be performed/computed as or as part of the standard SQL operator function. As noted above, because UDF expressions can be made into/as part of SQL operators, the processing of UDF expressions can be performed at/near the disk where the data is stored (to avoid excessive data shipping to other parts of a query plan). Moreover, UDF expressions made into/as part of SQL operators can be parallelized if such an optimization via compilation is possible. Other optimizations, as discussed above, may also be effectuated.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The term “non-transitory media,” and similar terms, as used herein refers to any media that store data and/or instructions that cause a machine to operate in a specific fashion. Such non-transitory media may comprise non-volatile media and/or volatile media. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700 or DBMS 124 (or the modules implemented therein)

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

1. A method, comprising:
receiving, at a compiler, a structured query language (SQL) query specified to include a user defined function (UDF) expression;
compiling, by the compiler, the SQL query by:
separating the SQL query into tokens;
parsing the tokens to determine semantics of the SQL query;
generating a query tree representation of the SQL query;
transforming the query tree representation into an optimizable format; and
generating an SQL query plan based on the query tree representation that includes the UDF expression transformed into or as part of a standard SQL operator; and
executing the SQL query plan, wherein the transformed UDF expression is performed as or part of the standard SQL operator.

2. The method of claim 1, further comprising at least one of parallelizing performance of the standard SQL operator and avoiding or minimizing data shipping.

3. The method of claim 2, wherein the parallelization of the performance of the standard SQL operator occurs across a plurality of partitions of the database.

4. The method of claim 2, wherein the parallelization of the performance of the standard SQL operator occurs across a plurality of executor server processes.

5. The method of claim 2, wherein the performance of the standard SQL operator occurs near data that is the target of the standard SQL operator or near a disk storing the data to avoid or minimize data shipping of the data.

6. The method of claim 1, wherein the UDF expression is written in a procedural language, and wherein the SQL query is written in a declarative language.

7. The method of claim 1, wherein the SQL query comprises one or more additional UDF expressions.

8. The method of claim 1, wherein compiling the SQL query comprises reading in the SQL query, the SQL query comprising textual input.

9. (canceled)

10. (canceled)

11. The method of claim 10, wherein building the query tree representation facilitates capturing a syntactic structure of the SQL query.

12. The method of claim 11, wherein the optimizable format comprises a canonical tree form.

13. The method of claim 1, wherein the optimizable format enables the compiler to place the UDF expression for performance at a location within the query tree representation.

14. A system, comprising:
a processor; and
a memory comprising instructions that when executed, cause the processor to:
read textual input representative of a database query, the database query specifying a user-defined function (UDF);
preprocess the database query by breaking the database query into one or more tokens;
parse the one or more tokens to check semantics of the database query;
generate a query tree representative of the database query;
transform the query tree into an optimizable format; and
generate a query plan based on the query tree that includes the UDF, wherein the UDF is transformed into or as part of a standard database query operator; and
execute the query plan, wherein the UDF is executed as or part of the database query operator.

15. The system of claim 14, wherein the instructions that when executed cause the processor to execute the query plan comprise instructions that when executed, further cause the processor to execute the UDF in parallel across a plurality of partitions of a database storing the data that is the subject of the database query.

16. The system of claim 14, wherein the instructions that when executed cause the processor to execute the query plan comprise instructions that when executed, further cause the processor to execute the UDF in parallel across a plurality of executor server processes.

17. The system of claim 14, further comprising avoiding or minimizing data shipping by computing the UDF as part of the standard database operator, the database operator function being executed near or at the data.

18. (canceled)

19. (canceled)

20. The system of claim 14, wherein the instructions that when executed cause the processor to to build the query tree enables capturing of a syntactic structure of the database query.

21. The system of claim 14, wherein the optimizable format comprises a canonical tree form.

22. The system of claim 14, wherein the memory comprises further instructions that when executed, further causes the processor to place the UDF for execution at a location within the query tree.

23. The system of claim 22, wherein the placement of the UDF expression for performance at the location of the query tree is based on selectively of a predicate expression of the database query.

24. The method of claim 13, wherein the placement of the UDF expression for performance at the location of the query tree is based on selectively of a predicate expression of the SQL query.
